(19) United States
(12) Patent Application Publication
(10) Pub. No.: US 2026/0278050 A1
(43) Pub. Date: Sep. 17, 2026

(54) AUTHENTICATION CONTROL APPARATUS, AUTHENTICATION CONTROL METHOD, AND NON-TRANSITORY COMPUTER READABLE MEDIUM

(71) Applicant: NEC Corporation, Tokyo (JP)

(72) Inventors: Yu TSUMURAYA, Tokyo (JP); Yusuke Mori, Tokyo (JP); Masatoshi Furukawa, Tokyo (JP); Sayo Minowa, Tokyo (JP); Akio Yoshioka, Tokyo (JP)

(73) Assignee: NEC Corporation, Tokyo (JP)

(21) Appl. No.: 19/461,998

(22) Filed: Jan. 28, 2026

(30) Foreign Application Priority Data
Mar. 11, 2025 (JP) 2025-038354

(51) Int. Cl. G06F 21/31

(52) U.S. Cl. CPC G06F 21/31

(57) ABSTRACT

An authentication control apparatus according to the present disclosure includes a first detection unit that detects first detection information including at least one of a motion of a terminal apparatus of a user and an action of the user with respect to the terminal apparatus, a second detection unit that detects second detection information that is information related to the first detection information and includes at least one of the motion of the terminal apparatus and the action of the user with respect to the terminal apparatus by a method different from that of the first detection unit, and an authentication control unit that controls authentication processing of the terminal apparatus of the user by collating the first detection information with the second detection information.

### INCORPORATION BY REFERENCE

This application is based upon and claims the benefit of priority from Japanese patent application No. 2025-038354, filed on Mar. 11, 2025, the disclosure of which is incorporated herein in its entirety by reference.

### TECHNICAL FIELD

The present disclosure relates to an authentication control apparatus, an authentication control method, and a program.

### BACKGROUND ART

JP 2020-135306 A discloses a display system that performs personal authentication based on a detection result of a first sensor and a detection result of a second sensor until a position input operation, for example, a touch operation is started in a case where a head mounted display (HMD) is worn. The first sensor is provided in a smartphone, and senses the action of the user on the smartphone. The second sensor is provided in an HMD and senses the positions of fingers.

### SUMMARY

In the display system disclosed in JP 2020-135306 A, in a case where an operation of a smartphone owned by another user is erroneously visually recognized and positions of fingers are sensed, there is a case where authentication of a terminal of the user is canceled.

In view of the above-described problems, an example object of the present disclosure is to provide an authentication control apparatus, an authentication control method, and a program capable of appropriately performing authentication processing on a terminal of a user.

An authentication control apparatus according to an example aspect of the present disclosure includes

a first detection unit that detects first detection information including at least one of a motion of a terminal apparatus of a user and an action of the user with respect to the terminal apparatus,

a second detection unit that detects second detection information that is information related to the first detection information and includes at least one of the motion of the terminal apparatus and the action of the user with respect to the terminal apparatus by a method different from that of the first detection unit, and

an authentication control unit that controls authentication processing of the terminal apparatus of the user by collating the first detection information with the second detection information.

An authentication control method according to an example aspect of the present disclosure includes processing of,

by a computer,

detecting first detection information including at least one of a motion of a terminal apparatus of a user and an action of the user with respect to the terminal apparatus,

detecting second detection information that is information related to the first detection information and includes at least one of the motion of the terminal apparatus and the action of the user with respect to the terminal apparatus by a method different from detection of the first detection information, and

controlling authentication processing of the terminal apparatus of the user by collating the first detection information with the second detection information.

A program according to an example aspect of the present disclosure causes

a computer to execute processing of,

detecting first detection information including at least one of a motion of a terminal apparatus of a user and an action of the user with respect to the terminal apparatus,

detecting second detection information that is information related to the first detection information and includes at least one of the motion of the terminal apparatus and the action of the user with respect to the terminal apparatus by a method different from detection of the first detection information, and

controlling authentication processing of the terminal apparatus of the user by collating the first detection information with the second detection information.

According to the present disclosure, it is possible to provide an authentication control apparatus, an authentication control method, and a program capable of appropriately performing authentication processing on a terminal of a user.

### BRIEF DESCRIPTION OF THE DRAWINGS

FIG. 1 is a block diagram illustrating an authentication control apparatus according to the present disclosure;

FIG. 2 is a flowchart illustrating an authentication control method according to the present disclosure;

FIG. 3 is a block diagram illustrating an authentication control system according to the present disclosure;

FIG. 4 is a diagram illustrating a state in which face authentication of a user is performed;

FIG. 5 is a flowchart illustrating an authentication control method according to the present disclosure;

FIG. 6 is a block diagram illustrating an authentication control system according to the present disclosure;

FIG. 7 is a flowchart illustrating an authentication control method according to the present disclosure;

FIG. 8 is a block diagram illustrating an authentication control system according to the present disclosure;

FIG. 9 is a flowchart illustrating an authentication control method according to the present disclosure;

FIG. 10 is a flowchart illustrating an authentication control method according to the present disclosure;

FIG. 11 is a block diagram illustrating an authentication control system according to the present disclosure;

FIG. 12 is a flowchart illustrating an authentication control method according to the present disclosure; and

FIG. 13 is a block diagram illustrating a configuration example of an HMD and a terminal apparatus according to the present disclosure.

### EXAMPLE EMBODIMENT

Hereinafter, the present disclosure will be described according to example embodiments, but the disclosure described in the claims is not limited to the following example embodiments. Not all of the configurations described in the example embodiments are essential as means for solving the problem. In the drawings, the same elements are denoted by the same reference signs, and redundant description will be omitted as necessary.

### First Example Embodiment

### Information Processing Apparatus

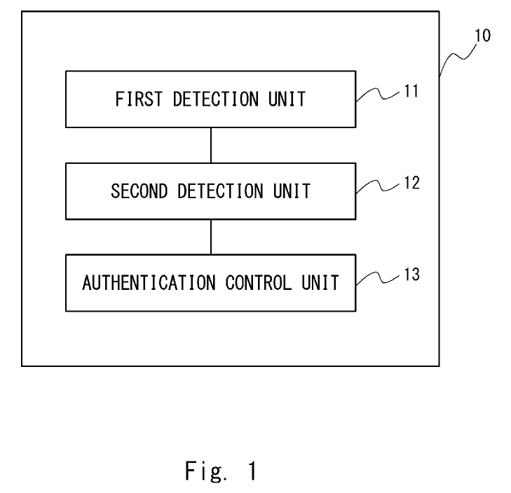

Hereinafter, a configuration of an authentication control apparatus according to the present disclosure will be described with reference to FIG. 1. FIG. 1 is a block diagram illustrating an authentication control apparatus according to the present disclosure. As illustrated in FIG. 1, an authentication control apparatus 10 includes a first detection unit 11, a second detection unit 12, and an authentication control unit 13.

The first detection unit 11 detects first detection information. The first detection information is information including at least one of the motion of the terminal apparatus of the user and the action of the user on the terminal apparatus. The motion of the terminal apparatus of the user is, for example, upward, downward, leftward, rightward, or rotational movement of the terminal apparatus. The action of the user on the terminal apparatus is, for example, an input operation of the user on the terminal apparatus, an action of the user swinging the terminal apparatus up, down, left, and right, or an operation of the user inclining the terminal apparatus.

The second detection unit 12 detects the second detection information by a method different from that of the first detection unit. The second detection information is information related to the first detection information, and is information including the second detection information including at least one of the motion of the terminal apparatus and the action of the user on the terminal apparatus.

For example, in a case where the first detection information is a motion of the terminal apparatus of the user, the second detection information is a motion of the terminal apparatus of the user detected by a method different from that of the first detection unit. In a case where the first detection information is the action of the user on the terminal apparatus, the second detection information is the action of the user on the terminal apparatus detected by a method different from that of the first detection unit. As described above, the second detection information is information related to the first detection information, and is information of the same type.

The authentication control unit 13 controls the authentication processing of the terminal apparatus of the user by collating the first detection information with the second detection information. Specifically, the authentication control unit 13 calculates the similarity between the first detection information and the second detection information, and performs control to execute authentication processing of the terminal apparatus of the user in a case where the similarity between the first detection information and the second detection information is a predetermined value or more. On the other hand, in a case where the similarity between the first detection information and the second detection information is less than the predetermined value, control is performed not to execute authentication processing of the terminal apparatus of the user. The similarity is, for example, a probability indicating a degree of similarity. The authentication processing indicates processing of performing personal authentication, and is typically face authentication.

As described above, the authentication control apparatus 10 according to the present disclosure controls the authentication processing of the terminal apparatus of the user by collating the first detection information with the second detection information. With such a configuration, the authentication control apparatus 10 according to the present disclosure can appropriately perform the authentication processing for the terminal of the user.

### Authentication Control Method

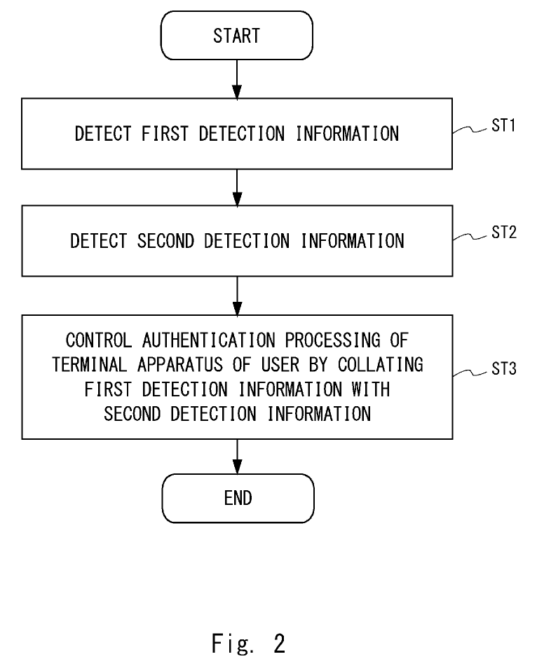

Next, an authentication control method according to the present disclosure will be described. FIG. 2 is a flowchart illustrating an authentication control method according to the present disclosure. Hereinafter, reference signs illustrated in FIG. 1 are appropriately used.

First, the first detection unit 11 detects first detection information including at least one of a motion of the terminal apparatus of the user and a motion of the user with respect to the terminal apparatus (step ST1).

Next, the second detection unit 12 detects the second detection information, which is information related to the first detection information and includes at least one of the motion of the terminal apparatus and the action of the user on the terminal apparatus, by a method different from that of the first detection unit 11 (step ST2).

Next, the authentication control unit 13 controls the authentication processing of the terminal apparatus of the user by collating the first detection information with the second detection information (step ST3).

As described above, in the authentication control method according to the present disclosure, the authentication processing of the terminal apparatus of the user is controlled by collating the first detection information with the second detection information. With such a configuration, in the authentication control method according to the present disclosure, the authentication processing of the terminal of the user can be appropriately performed.

### Second Example Embodiment

### Authentication Control System. Athentification Control Based on Mortion of Terminal Apparqtus

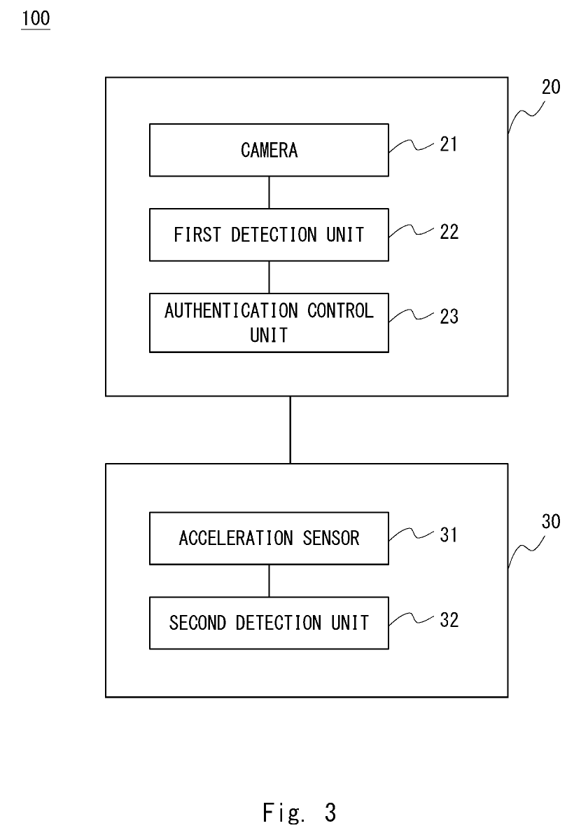

Hereinafter, a configuration of an authentication control system according to the present disclosure will be described with reference to FIG. 3. FIG. 3 is a block diagram illustrating an authentication control system according to the present disclosure. As illustrated in FIG. 3, an authentication control system 100 includes a head mounted display (HMD) 20 and a terminal apparatus 30. Hereinafter, a case where the first detection information and the second detection information are motions of the terminal apparatus of the user will be described as an example.

### HMD

As illustrated in FIG. 3, the HMD 20 includes a camera 21, a first detection unit 22, and an authentication control unit 23. The camera 21 acquires an image including the terminal apparatus 30 by capturing an environment around the user. FIG. 3 illustrates an example in which the HMD 20 includes the camera 21, but a depth sensor or an infrared camera may be used. The HMD 20 can more accurately capture the three-dimensional motion of the terminal apparatus 30 by using the depth sensor. The HMD 20 can detect the motion of the terminal apparatus 30 even in a dark place by using an infrared camera.

The first detection unit 22 detects the motion of the terminal apparatus 30 based on the image acquired by the camera 21. Specifically, the first detection unit 22 analyzes a change in the position of the terminal apparatus 30 between consecutive image frames, and specifies a motion pattern thereof.

The authentication control unit 23 controls the authentication processing of the terminal apparatus 30 of the user by collating the detection results of the first detection unit 22 and the second detection unit 32. Details of the second detection unit 32 will be described later. An example of authentication control by the authentication control unit 23 will be described.

For example, the authentication control unit 23 compares motions of the terminal apparatus 30 detected by the first detection unit 22 and the second detection unit 32, for example, motion patterns. The authentication control unit 23 calculates similarity between the motion patterns of the two. The authentication control unit 23 determines whether the similarity is equal to or more than a predetermined value, in other words, whether the motion patterns of the two are substantially the same.

In a case where it is determined that the motion patterns of the two are similar to each other (similarity is equal to or more than a predetermined value), in other words, in a case where it is determined that the motion patterns of the two are substantially the same, the authentication control unit 23 performs control to execute authentication processing of the terminal apparatus 30 of the user.

On the other hand, in a case of determining that the motion patterns of the two are not similar to each other (similarity is less than the predetermined value), in other words, in a case of determining that the motion patterns of the two are not substantially the same, the authentication control unit 23 performs control not to execute the authentication processing on the terminal apparatus 30 of the user. In this case, the user needs to perform normal authentication processing.

### Terminal Apparatus

As illustrated in FIG. 3, the terminal apparatus 30 includes an acceleration sensor 31 and a second detection unit 32. The terminal apparatus 30 is typically a terminal carried by the user.

The acceleration sensor 31 acquires information regarding acceleration of the terminal apparatus 30. FIG. 3 illustrates an example in which the terminal apparatus 30 includes the acceleration sensor 31, but a gyro sensor or a magnetic sensor may be used. The terminal apparatus 30 can detect the rotational motion more precisely by using the gyro sensor. The terminal apparatus 30 can detect a change in an absolute direction based on geomagnetism by using a magnetic sensor. Although FIG. 3 illustrates an example in which the terminal apparatus 30 includes the acceleration sensor 31, the terminal apparatus 30 may include a sensor that acquires information for specifying the motion of the terminal apparatus 30.

The second detection unit 32 acquires and processes data of the acceleration sensor 31 (information regarding the acceleration of the terminal apparatus 30), thereby detecting the motion of the terminal apparatus 30. Specifically, the second detection unit 32 calculates a moving direction and a speed of the terminal from the acceleration data, and specifies a motion pattern. The terminal apparatus 30 transmits the detection result by the second detection unit 32 to the HMD 20.

### Authentication Processing Example

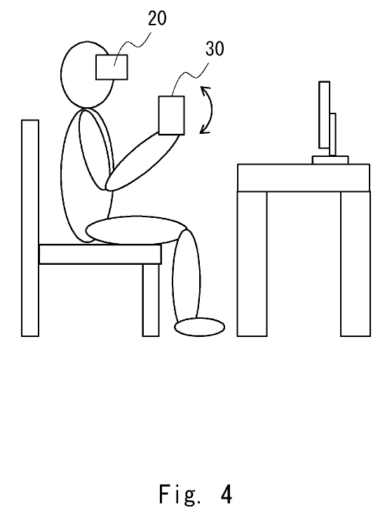

The authentication control system 100 will be specifically described with reference to FIG. 4. FIG. 4 is a diagram illustrating a state in which face authentication of a user is performed. In FIG. 4, the user wears the HMD 20 and randomly moves the terminal apparatus 30 while gripping the terminal apparatus 30. Then, each of the first detection unit 22 (see FIG. 3) of the HMD 20 and the second detection unit 32 (see FIG. 3) of the terminal apparatus 30 detects the motion of the terminal apparatus 30.

Then, the authentication control unit 23 compares these detection results (motion of the terminal apparatus 30 by the first detection unit 22 and motion of the terminal apparatus 30 by the second detection unit 32). In a case where both are substantially the same, the authentication control unit 23 performs control such that the authentication processing of the terminal apparatus 30 is executed (the authentication processing is omitted).

### Effects

Here, it is assumed that the user erroneously looks at another person’s terminal apparatus in a state of wearing the HMD 20. In this case, the first detection unit 22 detects the motion of another person's terminal apparatus. On the other hand, the second detection unit 32 detects the motion of the terminal apparatus of the user. Therefore, the authentication control unit 23 performs control so as not to execute the authentication processing (omit the authentication processing) of the terminal apparatus 30.

As described above, in the authentication control system 100, even if the user erroneously sees another person's terminal with the HMD 20 worn, it is possible to suppress execution of the authentication processing of the own terminal apparatus 30. Since the authentication control system 100 can appropriately execute and control the authentication processing regardless of the motion of any terminal apparatus, unauthorized authentication by a third party can be suppressed. Therefore, the authentication control system 100 has high security.

In the authentication control system 100, the authentication processing can be controlled by the random motion of the user. Therefore, in the authentication control system 100, as compared with the case of using the predetermined motion pattern determined in advance, it is also possible to suppress the third party from predicting the motion and executing the authentication processing incorrectly. Furthermore, it is also possible to save time and effort for the user to memorize a predetermined motion pattern determined in advance.

In the authentication control system 100, the user can perform the face authentication without taking the HMD 20 out of the way for the face authentication.

### Improvement in Accuracy

The HMD 20 may be configured to give an instruction to move the terminal apparatus 30 within the field of view of the user. With such a configuration, in a case where the field of view of the camera 21 of the HMD 20 is limited, for example, even in a case where the user's hand or a surrounding object blocks the field of view of the camera 21, the authentication control system 100 can accurately detect the motion of the terminal apparatus 30.

The HMD 20 may be provided with an iris authentication function. With such a configuration, the authentication control system 100 can further suppress authentication processing from being performed by a person other than the user.

Here, in a case where the HMD 20 is not fixed, for example, in a case where the head is moving, a deviation occurs between the motion of the terminal apparatus 30 in the first detection unit 22 and the motion of the terminal apparatus 30 by the second detection unit 32. Therefore, the authentication control system 100 may be configured to calculate the motion of the terminal apparatus 30 assumed at the time of fixing the HMD 20 from the sensing result of the sensor of the HMD 20, and collate the calculated motion of the terminal apparatus 30 with the motion of the terminal apparatus 30 by the second detection unit 32. With such a configuration, the authentication control system 100 can perform collation with high accuracy.

Although FIG. 3 illustrates an example in which the terminal apparatus 30 includes the acceleration sensor 31, the terminal apparatus 30 may be combined with another sensor, for example, a gyro sensor or a magnetic sensor. With such a configuration, the terminal apparatus 30 can detect the motion of the terminal apparatus 30 in a wider range, for example, the extremely slow motion of the terminal apparatus 30 and the minute motion of the terminal apparatus 30.

The terminal apparatus 30 may be configured to sense deterioration in accuracy of the acceleration sensor 31 and, in a case where it is determined that the accuracy is deteriorated, issue a warning notification to at least one of the HMD 20 and the terminal apparatus 30. In this case, the authentication control unit 23 may change, for example, lower a predetermined value of the similarity of the motion of the terminal apparatus 30 detected by the first detection unit 22 and the second detection unit 32. As a result, even if the accuracy with which the acceleration sensor 31 detects the motion of the terminal apparatus 30 is deteriorated, the authentication processing can be appropriately controlled.

The authentication control system 100 may be configured to perform time synchronization between the HMD 20 and the terminal apparatus 30, give a time stamp to the detected motion, and compare the motions in consideration of the time stamp. With such a configuration, even if there is a shift in the timing of motion detection of the terminal apparatus 30 between the HMD 20 and the terminal apparatus 30, the motion can be accurately compared by the time stamp.

### Authentication Control Method

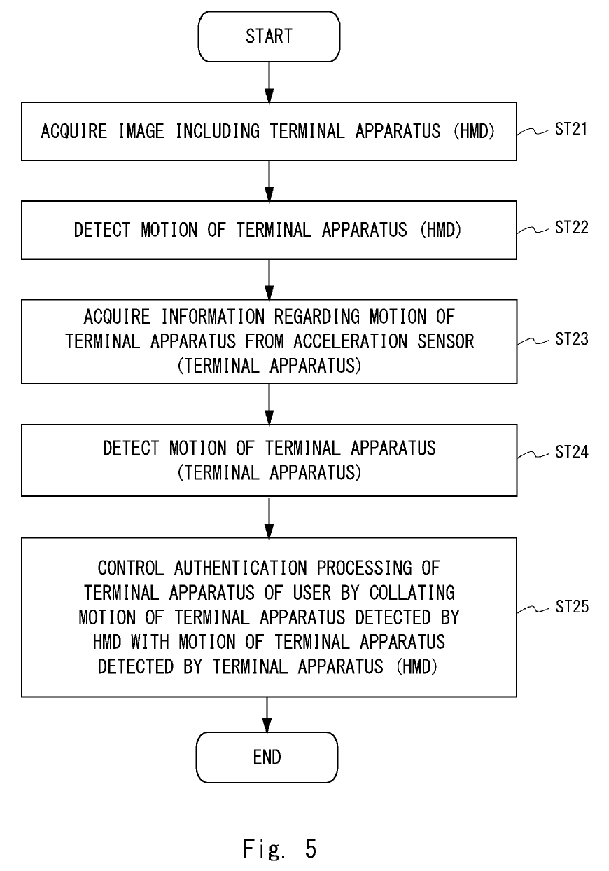

Next, an authentication control method according to the present disclosure will be described. FIG. 5 is a flowchart illustrating an authentication control method according to the present disclosure. Hereinafter, reference signs illustrated in FIG. 3 are appropriately used. Here, as illustrated in FIG. 4, it is assumed that the user wears the HMD 20, grips the terminal apparatus 30, and randomly moves the terminal apparatus. The parentheses illustrated in FIG. 5 indicate the subject of each step.

First, as illustrated in FIG. 5, the camera 21 acquires an image including the terminal apparatus 30 by imaging the environment around the user (step ST21). Next, as illustrated in FIG. 5, the first detection unit 22 detects the motion of the terminal apparatus 30 based on the image acquired by the camera 21 (step ST22).

Next, as illustrated in FIG. 5, the acceleration sensor 31 acquires information regarding the motion of the terminal apparatus 30 (step ST23). Next, as illustrated in FIG. 5, the second detection unit 32 detects the motion of the terminal apparatus 30 based on the data of the acceleration sensor 31 (step ST24).

Next, as illustrated in FIG. 5, the authentication control unit 23 controls the authentication processing of the terminal apparatus 30 of the user by collating the detection results of the first detection unit 22 and the second detection unit 32 (step ST25).

As described above, in the authentication control method according to the present disclosure, the authentication processing of the terminal apparatus 30 of the user is controlled by comparing the motion of the terminal apparatus 30 detected in the HMD 20 and the terminal apparatus 30. With such a configuration, in the authentication control method according to the present disclosure, the authentication processing of the terminal apparatus 30 can be appropriately controlled regardless of the motion of the terminal apparatus 30.

### Third Example Embodiment

### Authentication Control System. Authentication Control Based on User's Action on Terminal Apparatus

Hereinafter, a configuration of an authentication control system according to the present disclosure will be described. Here, a case where the first detection information and the second detection information are actions of the user with respect to the terminal apparatus of the user will be described as an example. The authentication control system according to the present disclosure includes functional blocks similar to those in FIG. 3. Therefore, in the following description, for each functional block, the description of a similar configuration will be appropriately omitted. In the following description, reference signs illustrated in FIG. 3 are used.

### HMD

The HMD 20 is, for example, AR glasses with a camera. In the AR glasses, digital information is superimposed and displayed in the real world without blocking the user's field of view. The HMD 20 captures the field of view of the user by the built-in camera of the AR glasses and performs image processing.

The HMD 20 may use an infrared sensor instead of the camera 21. The HMD 20 can accurately detect the motion of the user's hand even in a dark place or a backlight environment by using the infrared sensor.

The first detection unit 22 detects a motion of the user with respect to the terminal apparatus, for example, a motion of a hand or a motion of a finger of the user based on the image acquired by the camera 21. The first detection unit 22 may detect the action of the user on the terminal apparatus using image processing software. The image processing software is software that can recognize the position, motion, and gesture of the user's hand using a machine learning algorithm.

### Terminal Apparatus

The terminal apparatus 30 is, for example, a smartphone equipped with a touch screen. The terminal apparatus 30 includes a touch sensor and can detect the motion of the user's finger. The terminal apparatus 30 may use a pressure sensing sensor instead of the touch screen. By using the pressure sensing sensor, the terminal apparatus 30 is less susceptible to humidity and dirt, and more accurate input detection is possible.

The second detection unit 32 detects an action of the user with respect to the terminal apparatus, for example, an input pattern (input) of the user. The second detection unit 32 uses software that detects an input on the touch screen of the terminal apparatus 30. The second detection unit 32 acquires detailed information such as the position, movement, speed, and pressure of the touch by using this software, and detects the input pattern of the user.

### Authentication Control

The authentication control unit 23 uses, for example, software to compare and determine the detection results of the first detection unit 22 and the second detection unit 32. For example, the authentication control unit 23 collates the motion of the hand or the motion of the finger of the user detected by the HMD 20 with the pattern of the touch input detected by the terminal apparatus 30, and performs control so as to execute the authentication processing (omit the authentication processing) in a case where both are substantially the same. In other words, in a case where the similarity between the motion of the hand or the motion of the finger of the user detected by the HMD 20 and the pattern of the touch input detected by the terminal apparatus 30 is equal to or more than a predetermined value, control is performed such that the authentication processing is executed (the authentication processing is omitted).

Here, there is a possibility that the motion of the hand detected in the HMD 20 and the touch input detected in the terminal apparatus 30 do not match due to the shaking of the hand of the user or an unstable operation, and the authentication processing of the terminal apparatus 30 cannot be appropriately performed. However, in the authentication control system according to the present disclosure, by using the similarity, it is possible to take into account an individual difference and an operation environment of the user, and thus, it is possible to reliably control the authentication processing.

### Effects

As described above, in the authentication control system according to the present disclosure, the authentication processing of the terminal apparatus 30 of the user is controlled by comparing the action of the user with respect to the terminal apparatus of the user detected in the HMD 20 and the terminal apparatus 30. With such a configuration, in the authentication control system according to the present disclosure, the user can appropriately control the authentication processing by moving (operating) with respect to the terminal apparatus. In the authentication control system according to the present disclosure, an additional authentication procedure is also unnecessary.

The authentication control system according to the present disclosure uses information between the HMD 20 and the terminal apparatus 30. Therefore, in the authentication control system according to the present disclosure, since unauthorized authentication by another person can be suppressed, security is high.

### Improvement in Accuracy

The camera 21 may be configured to automatically adjust the sensitivity of the camera according to the illumination condition of the surrounding environment of the user. This makes it possible to accurately detect the motion of the user's hand even in a dark place or a strong backlight environment. Similar effects can be obtained by using the infrared sensor.

An instruction to move the terminal apparatus 30 within the field of view of the user may be given. With such a configuration, in a case where the field of view of the camera 21 of the HMD 20 is limited, for example, even in a case where the user's hand or a surrounding object blocks the field of view of the camera 21, the motion of the user's hand can be accurately detected.

In a case where the user visually recognizes the terminal apparatus 30 via the HMD 20, a predetermined touch input pattern may be displayed on the terminal apparatus 30. With such a configuration, the user can perform an input operation so as to trace a predetermined touch input pattern on the terminal apparatus 30. In other words, a predetermined touch input pattern is displayed on the terminal apparatus 30 to guide the motion of the hand of the user. The touch pattern may be displayed within the field of view of the HMD 20 so that the pattern of the touch input is invisible to other users. At this time, the terminal apparatus 30 may be recognized, and the touch pattern may be displayed so as to be superimposed on the terminal apparatus 30. As a result, the authentication control unit 23 can control the authentication processing by collating the motion of the hand of the user with the pattern of the touch input.

### Fourth Example Embodiment

### Authentication Control System

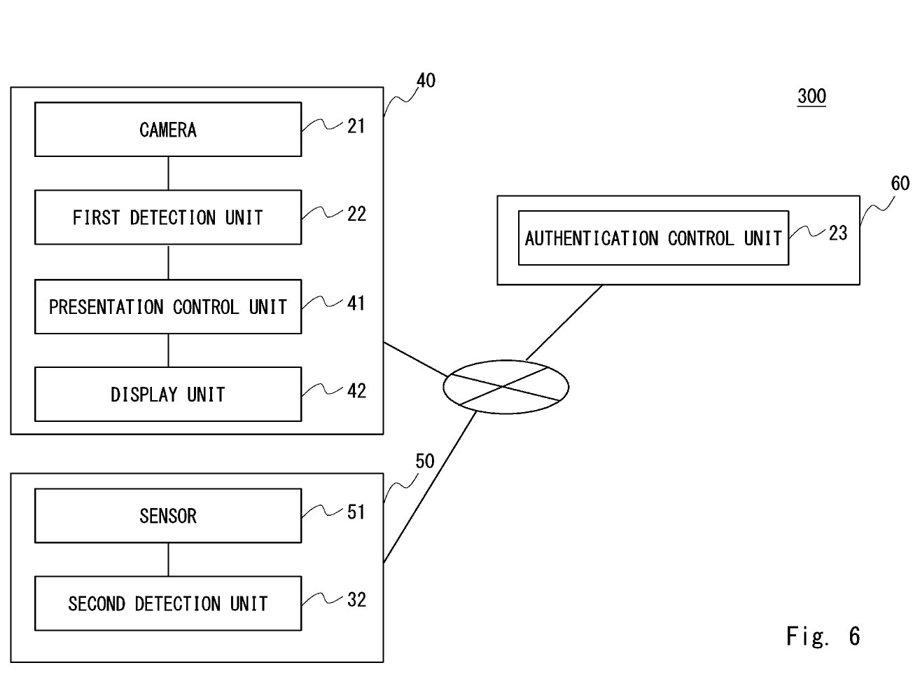

Hereinafter, a configuration of an authentication control system according to the present disclosure will be described with reference to FIG. 6. FIG. 6 is a block diagram illustrating an authentication control system according to the present disclosure. As illustrated in FIG. 6, the authentication control system 100 includes an HMD 40, a terminal apparatus 50, and a server 60. The HMD 40, the terminal apparatus 50, and the server 60 can communicate with each other. Hereinafter, a case where the first detection information and the second detection information are motions of the terminal apparatus of the user will be described as an example.

An authentication control system 300 illustrated in FIG. 6 is characterized in that a presentation control unit 41 controls the HMD 40 or the terminal apparatus 50 to present the instruction information to the user. The instruction information indicates an instruction related to an action of the user on the terminal apparatus. Hereinafter, the authentication control system 300 will be described in detail.

### HMD

As illustrated in FIG. 6, the HMD 40 includes a camera 21, a first detection unit 22, the presentation control unit 41, and a display unit 42. Since the camera 21 and the first detection unit 22 have configurations similar to those illustrated in FIG. 3, the description thereof will be omitted. The HMD 40 transmits information regarding the motion of the terminal apparatus 50 detected by the first detection unit 22 to the server 60.

The camera 21 may be a 3D camera including a depth sensor. As a result, the HMD 40 can more accurately capture the motion of the terminal apparatus 50 in three dimensions, and the authentication accuracy is improved.

The presentation control unit 41 controls the HMD 40 or the terminal apparatus 50 to present instruction information indicating an instruction regarding an action of the user with respect to the terminal apparatus. Specifically, the presentation control unit 41 controls the HMD 40 to present the instruction information from the display unit 42 of the HMD 40. The presentation control unit 41 controls the terminal apparatus 50 to present the instruction information from a display unit (not illustrated in FIG. 6) of the terminal apparatus 50.

The HMD 40 may have a voice guidance function in addition to the display unit 42. In this case, the presentation control unit 41 controls the voice guidance function of the HMD 40 so as to utter the instruction information. This also enables an auditory instruction. The HMD 40 may be configured to be able to select an instruction method according to the situation of the user.

### Terminal Apparatus

As illustrated in FIG. 6, the terminal apparatus 50 includes a sensor 51 and a second detection unit 32. The sensor 51 is, for example, a gyro sensor, and the second detection unit 32 detects the motion of the terminal apparatus 50 based on the information acquired by the gyro sensor. The terminal apparatus 50 transmits information regarding the motion of the terminal apparatus 50 detected by the second detection unit 32 to the server 60.

The sensor 51 is not limited to a gyro sensor, and may be a combination of an acceleration sensor and a magnetic sensor. As a result, the sensor 51 can detect more various motion of the terminal apparatus 50.

### Server

The server 60 includes the authentication control unit 23. The authentication control unit 23 controls the authentication processing of the terminal apparatus 50 based on the information regarding the motion of each terminal received from the HMD 40 and the terminal apparatus 50. Since the authentication control unit 23 has a configuration similar to that illustrated in FIG. 3, a detailed description thereof will be omitted.

The authentication control unit 23 of the server 60 may execute processing by edge computing. As a result, the authentication control unit 23 of the server 60 can locally control the authentication processing, and reduction of communication delay and enhancement of privacy protection can be expected.

### Authentication Control Method

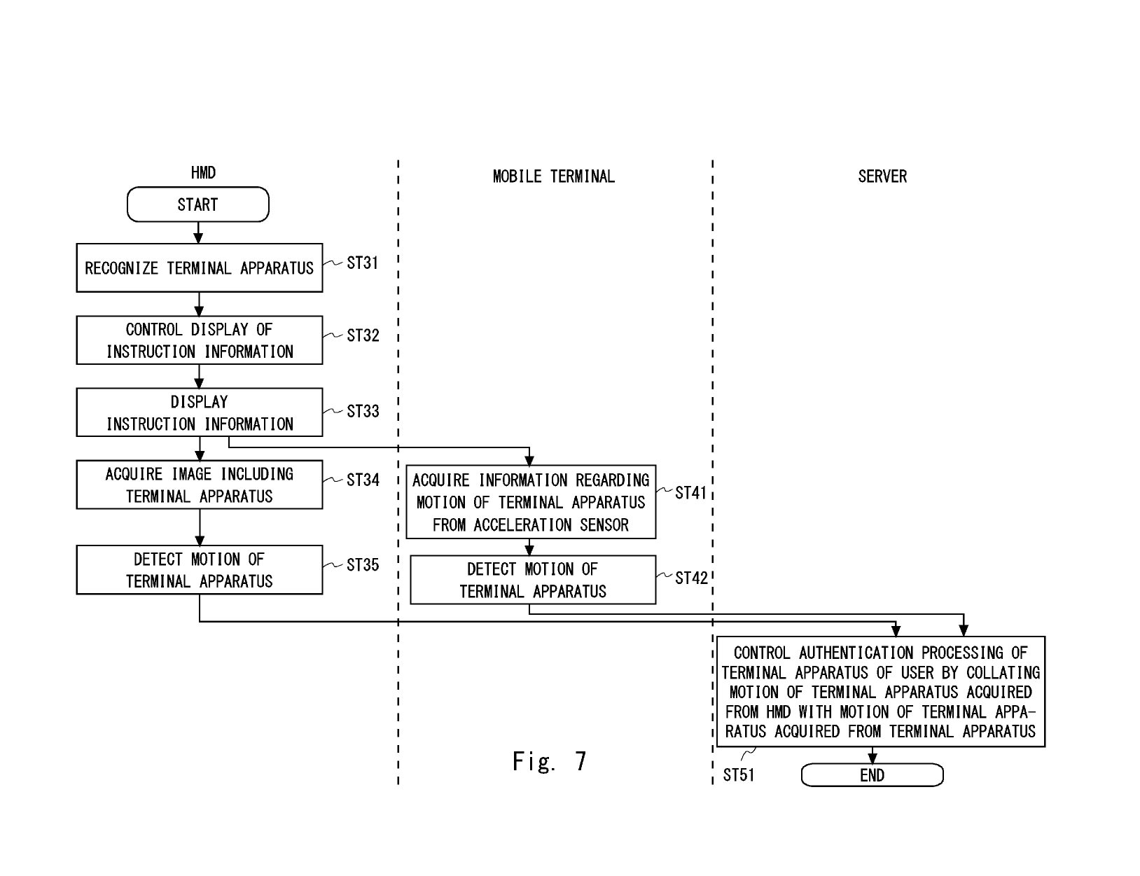

Next, an authentication control method according to the present disclosure will be described. FIG. 7 is a flowchart illustrating an authentication control method according to the present disclosure. Hereinafter, reference signs illustrated in FIG. 6 are appropriately used. Here, as illustrated in FIG. 4, it is assumed that the user wears the HMD 40 and grips the terminal apparatus 50.

First, the camera 21 of the HMD 40 captures an image of the environment around the user, and the first detection unit 22 recognizes the terminal apparatus 50 from the image (step ST31).

Next, the presentation control unit 41 of the HMD 40 controls the HMD 40 to display the instruction information on the display unit 42 (step ST32). This instruction information instructs a specific motion such as “swing the terminal apparatus up and down three times”, for example. As a result, the user moves the terminal apparatus 50 according to the displayed instruction information. Next, the first detection unit 22 of the HMD 40 detects the motion of the terminal apparatus 50 based on the image acquired by the camera 21 (step ST34 and step ST35).

The second detection unit 32 of the terminal apparatus 50 detects the motion of the terminal apparatus 50 based on the data of the sensor 51 (step ST41 and step ST42).

Next, each of the first detection unit 22 and the second detection unit 32 transmits information regarding the detected motion of the terminal apparatus 50 to the server 60. As a result, the server 60 acquires information regarding the motion of the terminal apparatus 50 detected by each of the first detection unit 22 and the second detection unit 32.

Next, the authentication control unit 23 of the server 60 controls the authentication processing of the terminal apparatus 50 of the user by collating both the received detection results (step ST51). Since the details of the authentication control unit 23 are similar to those in FIG. 5, the description thereof will be omitted. The server 60 may be configured to notify the terminal apparatus 50 of the control result of the authentication processing in accordance with the control of the authentication processing.

### Effects

As described above, in the authentication control system 300, the user operates on the terminal apparatus 50 according to the instruction information. As a result, the motion of the terminal apparatus 50 to be sensed by the HMD 40 is limited. Therefore, the authentication control system 300 can sense the motion of the terminal apparatus 50 more easily and accurately. In the authentication control system 300, even if the user erroneously sees another person's terminal with the HMD 40 worn, execution of the authentication processing of the own terminal apparatus 50 can be further suppressed.

In the authentication control system 300, since the user reproduces the action of the instruction information, a possibility that a third party accidentally reproduces the same motion is reduced, and security is improved.

In the authentication control system 300, the user only needs to operate on the terminal apparatus 50 according to the instruction information. Therefore, in a case where the authentication control system 300 is used, the user can easily authenticate the terminal apparatus even if the user wears the HMD 40. As a result, the burden on the user is reduced, and smooth authentication can be performed.

### Improvement in Accuracy

The HMD 40 may be configured to add a voice guidance function and transmit the instruction information to the user by voice. With such a configuration, the HMD 40 can notify the user of appropriate instruction information even in a case where a visual instruction cannot be given to the user via the display unit 42, for example, in a case where an action instruction cannot be displayed due to a failure.

The presentation control unit 41 may be configured to give an instruction to move the terminal apparatus 50 within the field of view of the user. At this time, the presentation control unit 41 may control the HMD 40 to display the authenticatable region in the field of view of the user. In other words, the presentation control unit 41 displays to the user so that the action can be performed within the predetermined range The authenticatable region may be a region in which the HMD 40 can recognize the motion of the terminal apparatus 50, and the display form is not limited. For example, a frame may be displayed in a region where the presentation control unit 41 can recognize the motion of the terminal apparatus 50, and guidance may be provided to move the terminal within the frame. At this time, the frame may be made smaller than a field of view or an instruction to move so as to be contained within the frame may be given, so that the terminal apparatus 50 that has been moved does not go out of the field of view of the HMD 40. The HMD 40 may recognize an object in the field of view of the user including the terminal apparatus 50 and a distance to the object, and display the authenticatable region at a position where an object other than the terminal apparatus 50 does not block the field of view. At this time, the above guidance may be displayed together. Since recognition of an object in a user's field of view and a distance to the object can be implemented by application of an existing technology, a more detailed description will be omitted.

### Fifth Example Embodiment

### Authentication Control System

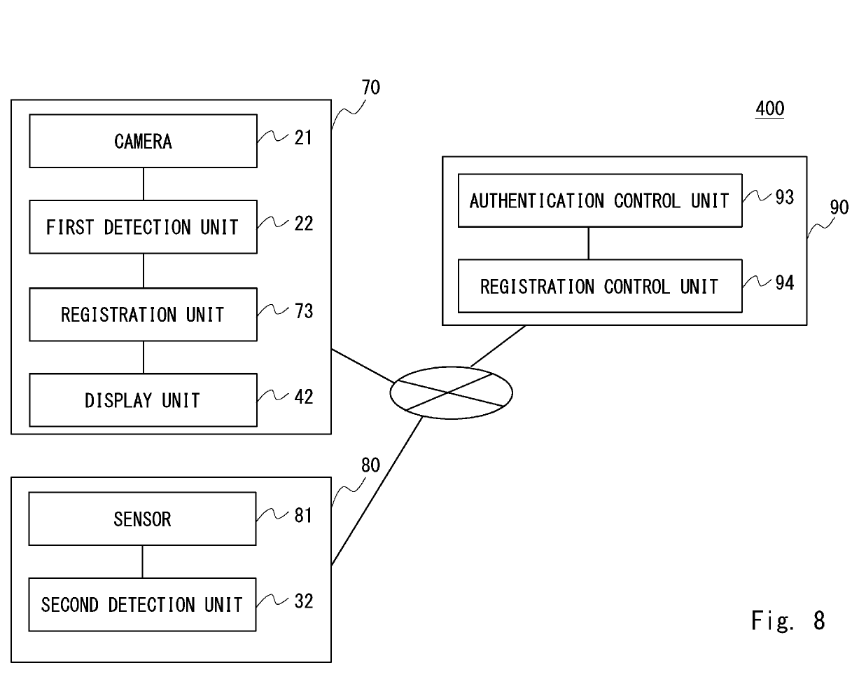

Hereinafter, a configuration of an authentication control system according to the present disclosure will be described with reference to FIG. 8. FIG. 8 is a block diagram illustrating an authentication control system according to the present disclosure. As illustrated in FIG. 8, an authentication control system 400 includes an HMD 70, a terminal apparatus 80, and a server 90, and the HMD 70, the terminal apparatus 80, and the server 90 are configured to be communicable with each other.

The authentication control system 400 illustrated in FIG. 8 is characterized in that pattern information indicating the motion of the user and the motion of the terminal apparatus accompanying the motion of the user is registered, and the pattern information is further used in the authentication processing control. Hereinafter, the authentication control system 400 will be described in detail. A case where the first detection information and the second detection information are motions of the terminal apparatus of the user will be described below as an example.

### HMD

As illustrated in FIG. 8, the HMD 70 includes a camera 21, a first detection unit 22, a registration unit 73, and a display unit 42. Since the camera 21, the registration unit 73, and the display unit 42 have configurations similar to those illustrated in FIG. 3, the description thereof will be omitted.

The registration unit 73 registers pattern information including at least one of the motion of the user and the motion of the terminal apparatus accompanying the motion of the user. For example, the registration unit 73 registers pattern information indicating a motion of spreading the user's hand and a motion of the terminal apparatus accompanying the motion of spreading the user's hand. The registration unit 73 can register user's favorite pattern information.

The HMD 70 transmits the information regarding the motion of the terminal apparatus 50 detected by the first detection unit 22 and the pattern information by the registration unit 73 to the server 60.

### Terminal Apparatus

As illustrated in FIG. 8, the terminal apparatus 80 includes a sensor 81 and a second detection unit 32. The sensor 81 is, for example, a six-axis sensor. The six-axis sensor includes, for example, a combination of a three-axis acceleration sensor and a three-axis gyro sensor. As a result, the sensor 81 can detect more detailed motion of the terminal apparatus 80.

Since the second detection unit 32 has a configuration similar to that illustrated in FIG. 3, the description thereof will be omitted. The terminal apparatus 50 transmits information regarding the motion of the terminal apparatus 50 detected by the second detection unit 32 to the server 60.

### Server

The server 90 includes an authentication control unit 93 and a registration control unit 94. The authentication control unit 93 collates the information regarding the motion of each terminal received from the HMD 70 and the terminal apparatus 80. Further, the authentication control unit 93 controls the authentication processing by performing collation including the pattern information.

The registration control unit 94 controls the pattern information registration processing of the registration unit 73 based on the information acquired by the HMD 70 and the terminal apparatus 80. Details will be described in the following flowcharts.

### Authentication Control Method

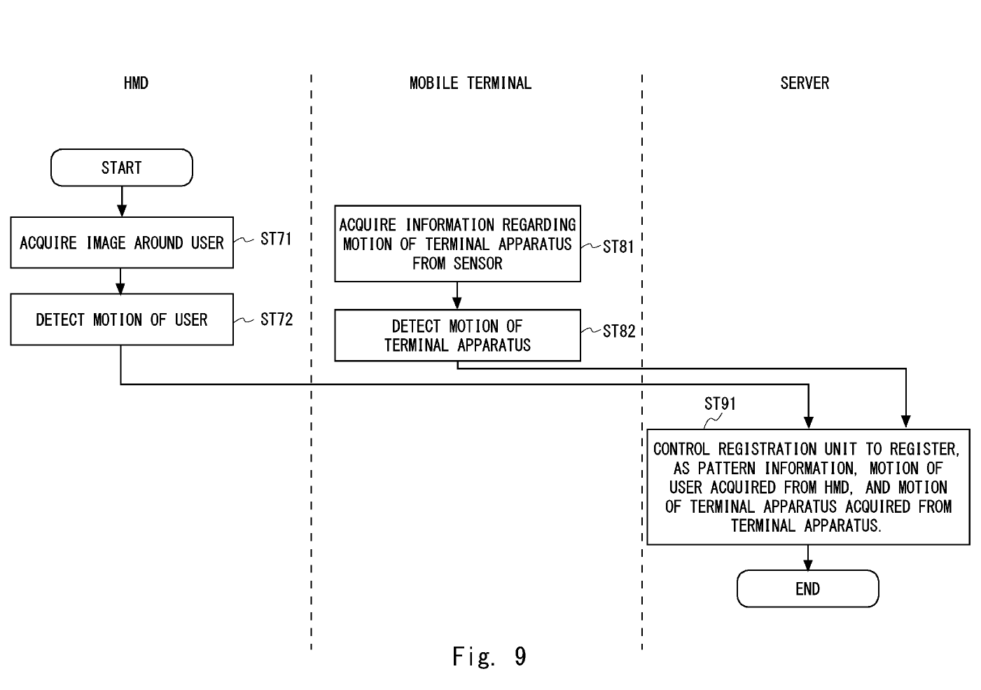

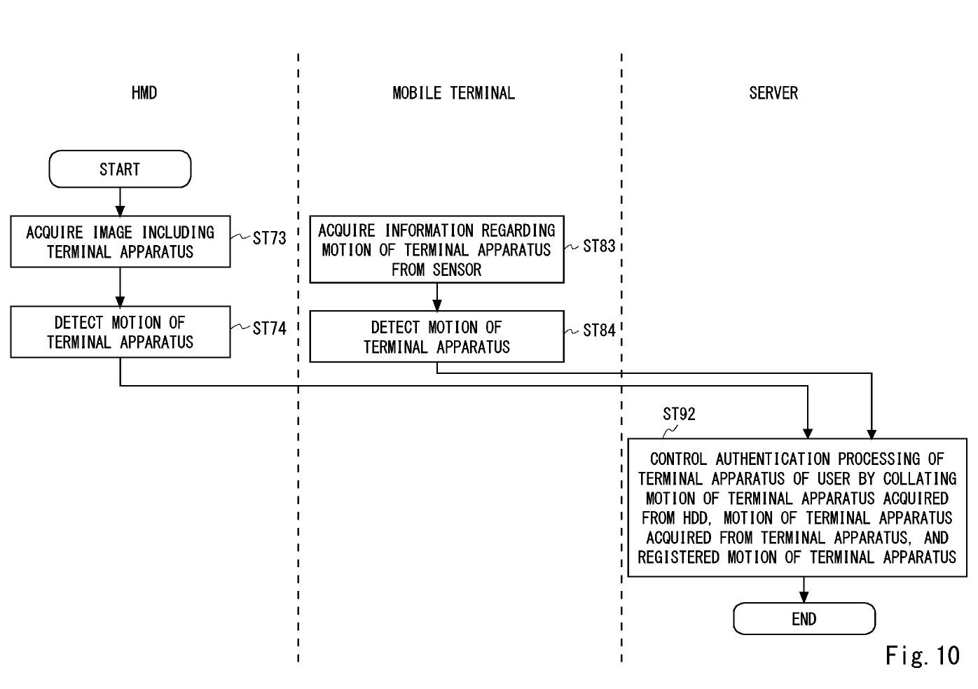

Next, an authentication control method according to the present disclosure will be described. FIGS. 9 and 10 are flowcharts illustrating an authentication control method according to the present disclosure. FIG. 9 is a flowchart illustrating a method of registering pattern information. FIG. 10 is a flowchart illustrating a method of controlling the authentication processing. Hereinafter, reference signs illustrated in FIG. 8 are appropriately used.

### Registration of Pattern Information

First, the user starts the pattern information registration mode. Specifically, a registration procedure is displayed on the display unit 42 of the HMD 70, and the user operates according to the registration procedure. Here, it is assumed that the user performs an action of spreading a hand. In the registration procedure, a user's action may be designated, or a user's preferred action may be performed.

Next, as illustrated in FIG. 9, the camera 21 of the HMD 70 acquires an image around the user (step ST71). Next, as illustrated in FIG. 9, the first detection unit 22 detects the motion of the user (action of spreading the hand) based on the image by the camera 21 (step ST72). The HMD 70 transmits the detection result to the server 60.

As illustrated in FIG. 9, the terminal apparatus 80 acquires information regarding the motion of the terminal apparatus 80 (the motion of the terminal apparatus 80 accompanying the action of spreading the hand) using the sensor 81 (step ST81). Next, as illustrated in FIG. 9, the second detection unit 32 detects the motion of the terminal apparatus 80 (the motion of the terminal apparatus 80 accompanying the action of spreading the hand) based on the information of the sensor (step ST82). The terminal apparatus 80 transmits the detection result to the server 60.

As illustrated in FIG. 9, the authentication control unit 93 of the server 90 executes the following processing. The authentication control unit 93 controls the registration unit 73 to register the motion of the user (the action of spreading a hand) received from the HMD 70 and the motion of the terminal apparatus 80 (the motion of the terminal apparatus 80 accompanying the action of spreading a hand) received from the terminal apparatus 80 as pattern information (step ST91). Thus, the user's favorite pattern information can be registered.

Although not illustrated in FIG. 9, in step ST72, the first detection unit 22 may detect the motion of the terminal apparatus 80 (the motion of the terminal apparatus 80 accompanying the action of spreading the hand). In step ST82, the second detection unit 32 may further detect the motion of the user (action of spreading the hand). That is, one of the first detection unit 22 and the second detection unit 32 may detect the motion of the user (action of spreading a hand), and the other of the first detection unit 22 and the second detection unit 32 may detect the motion of the terminal apparatus 80 (motion of the terminal apparatus 80 accompanying the action of spreading the hand).

In step ST72, the first detection unit 22 may be configured to detect a motion of the terminal apparatus 80 (a motion of the terminal apparatus 80 accompanying the action of spreading a hand), and in step ST81, the second detection unit 32 may be configured to detect a motion of the terminal apparatus 80 (a motion of the terminal apparatus 80 accompanying the action of spreading a hand).

It similarly applies to the motion of the user (action of spreading the hand). That is, the same information may be detected by the first detection unit 22 and the second detection unit 32.

In a case where the same information (information regarding the motion of the user or information regarding the motion of the terminal apparatus 80) is received from each of the HMD 70 and the terminal apparatus 80, the authentication control unit 93 controls the registration unit 73 to register the information as pattern information. In a case where different information (information regarding the motion of the user and information regarding the motion of the terminal apparatus 80) is received from each of the HMD 70 and the terminal apparatus 80, the authentication control unit 93 controls the registration unit 73 to register the information as pattern information.

### Control of Authentication Processing

At the time of authentication, the user performs a motion (action of spreading a hand) similar to that at the time of registration. As a result, as illustrated in FIG. 10, the HMD 70 acquires an image including the terminal apparatus 80 (step ST73). As illustrated in FIG. 10, the HMD 70 detects the motion of the terminal apparatus 80 (the motion of the terminal apparatus 80 accompanying the action of spreading the hand) based on the image (step ST74). The HMD 70 transmits the detection result to the server 60.

As illustrated in FIG. 10, the terminal apparatus 80 acquires information regarding the motion of the terminal apparatus 80 (the motion of the terminal apparatus 80 accompanying the action of spreading the hand) using the sensor 81 (step ST83). Next, as illustrated in FIG. 10, the second detection unit 32 detects the motion of the terminal apparatus 80 (the motion of the terminal apparatus 80 accompanying the action of spreading the hand) based on the information of the sensor (step ST84). The terminal apparatus 80 transmits the detection result to the server 60.

Next, as illustrated in FIG. 10, the authentication control unit 93 of the server 90 controls authentication processing of the terminal apparatus 80 by collating three items, namely, motions of the terminal apparatus 80 received from the HMD 70 and the terminal apparatus 80, and registered pattern information (step ST92).

A specific description will be given. The authentication control unit 93 of the server 90 collates the motion of the terminal apparatus 80 from the HMD 70 (the motion of the terminal apparatus 80 accompanying the action of spreading the hand) with the motion of the terminal apparatus 80 from the terminal apparatus 80 (the motion of the terminal apparatus 80 accompanying the action of spreading the hand). This is similar to the processing of the authentication control unit 23 illustrated in FIG. 3. Here, it is assumed that the motions of the terminal apparatus 80 from the HMD 70 and the terminal apparatus 80 are substantially the same.

Next, the authentication control unit 93 collates the motions of the terminal apparatus 80 from the HMD 70 and the terminal apparatus 80 with the motion of the terminal apparatus 80 included in the registered pattern information. For example, the authentication control unit 93 calculates the matching degree between the two. In a case where the matching degree exceeds a set threshold value, the authentication control unit 93 performs control to execute authentication processing of the terminal apparatus 80. On the other hand, in a case where the matching degree does not exceed the set threshold value, the authentication control unit 93 controls not to execute the authentication processing of the terminal apparatus 80.

Here, an example has been described in which the authentication control unit 93 registers the motion of the terminal apparatus 80 accompanying the motion of the user, and collates the motions of the terminal apparatus 80 detected by the HMD 70 and the terminal apparatus 80 with the registered motion of the terminal apparatus 80. However, the present invention is not limited thereto, and the authentication control unit 93 may register the motion of the user, collate the motions of the user with respect to the terminal apparatus detected by the HMD 70 and the terminal apparatus 80 using the registered motion of the user, and control the authentication processing of the terminal apparatus 80.

### Effects

As described above, the authentication control system 400 controls the authentication processing of the terminal apparatus 80 by collating the three pieces of motions of the terminal apparatus 80 received from the HMD 70 and the terminal apparatus 80 and the registered pattern information. With such a configuration, in the authentication control system 400, since the user can set the motion pattern by himself/herself, a more personalized authentication method can be implemented. As a result, in the authentication control system 400, the security level is improved, and unauthorized authentication by another person can be suppressed.

The authentication control system 400 can create an authentication pattern with higher security by combining motions of both the HMD and the mobile terminal. As described above, in the authentication control system 400, a security level is greatly improved as compared with generally performed authentication of a single terminal apparatus.

### Improvement in Accuracy

The authentication control system 400 may be configured to register a plurality of pieces of pattern information. The user may select and authenticate a plurality of patterns according to the situation. With such a configuration, even if the user cannot reproduce the same motion as at the time of registration due to injury or fatigue, the authentication processing of the terminal apparatus of the user can be appropriately performed.

The authentication control system 400 may acquire environmental conditions, for example, conditions related to brightness, temperature, and humidity, and adjust the sensitivity of the sensor 81. With such a configuration, in the authentication control system 400, the pattern information of the user can be appropriately registered according to the change in the environment of the user.

The authentication control system 400 (registration control unit 94) may be configured to present the user with a motion that is not easily affected by environmental conditions, for example, conditions regarding brightness, temperature, and humidity, for example, a vigorous motion such as a motion using the entire body such as a bending and stretching motion or a hand swinging. As a result, the authentication control system 400 can appropriately register the pattern information of the user.

### Sixth Example Embodiment

### Authentication Control System

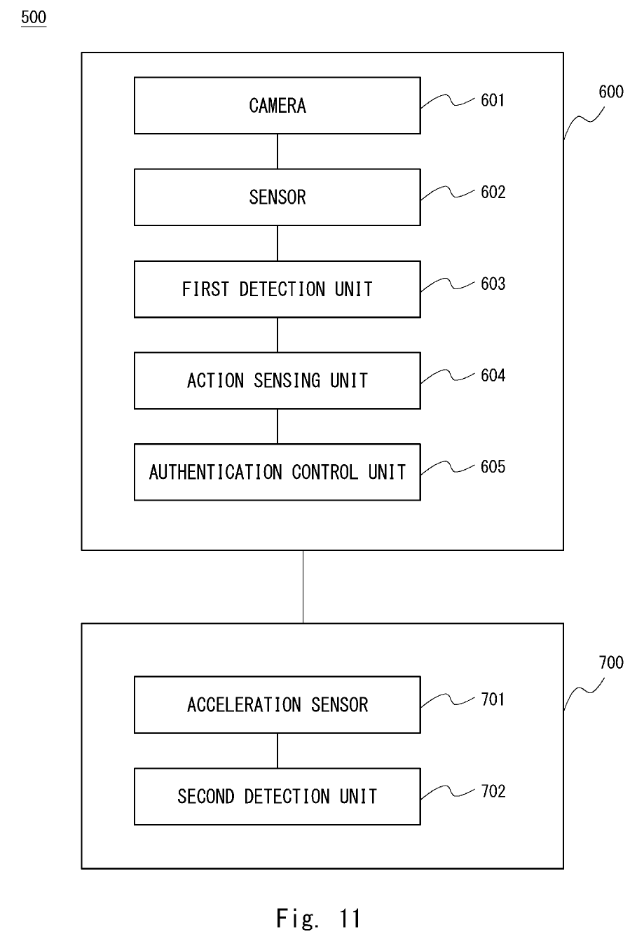

Hereinafter, a configuration of an authentication control system according to the present disclosure will be described with reference to FIG. 11. FIG. 11 is a block diagram illustrating an authentication control system according to the present disclosure. As illustrated in FIG. 11, an authentication control system 500 includes an HMD 600 and a terminal apparatus 700.

The authentication control system 500 illustrated in FIG. 11 is characterized in that the processing of the first detection unit, the second detection unit, and the authentication control unit is executed in a case where a predetermined motion of the user is sensed. Hereinafter, the authentication control system 500 will be described in detail. A case where the first detection information and the second detection information are motions of the terminal apparatus of the user will be described below as an example.

### HMD

The HMD 600 includes a camera 601, a sensor 602, a first detection unit 603, an action sensing unit 604, and an authentication control unit 605. Since the camera 601 is similar to that in FIG. 3, the description thereof will be omitted. The sensor 602 is, for example, a gyro sensor, and can more accurately detect the rotational motion of the HMD 600. The sensor 602 may be an inertial measurement unit (IMU).

The action sensing unit 604 senses a predetermined motion of the user based on the image of the camera 601 and the data of the sensor 602. The predetermined motion of the user is, for example, a motion in which the user swings the head or bends and stretches. The predetermined motion of the user includes gripping of the terminal apparatus 700 by the user.

In a case where a predetermined action registered in a database of a server (not illustrated in FIG. 11) matches the sensed action, the action sensing unit 604 determines that the action is the predetermined motion of the user. The action sensing unit 604 is not limited to complete matching, and may be configured to determine that the motion is the predetermined motion of the user in a case where the matching degree is a predetermined value or more.

On the other hand, in a case where the sensed action is different from the predetermined action registered in the database of the server (not illustrated in FIG. 11), the action sensing unit 604 determines that the motion is different from the predetermined motion of the user.

In a case where the action sensing unit 604 senses a predetermined motion of the user, the first detection unit 603 and the authentication control unit 605 start each processing. In a case where the action sensing unit 604 does not sense the predetermined motion of the user, the first detection unit 603 and the authentication control unit 605 do not start each processing. The other configurations of the first detection unit 603 and the authentication control unit 605 are similar to those in FIG. 3, and thus the description thereof is omitted.

### Terminal Apparatus

The terminal apparatus 700 includes an acceleration sensor 701 and a second detection unit 702. Since the acceleration sensor 701 is similar to that in FIG. 3, the description thereof will be omitted.

The second detection unit 702 starts the processing in a case where the action sensing unit 604 senses a predetermined motion of the user. In a case where the action sensing unit 604 does not sense the predetermined motion of the user, the second detection unit 702 does not start the processing. The other configurations of the second detection unit 702 are similar to those of FIG. 3, and thus the description thereof is omitted.

### Authentication Control Method

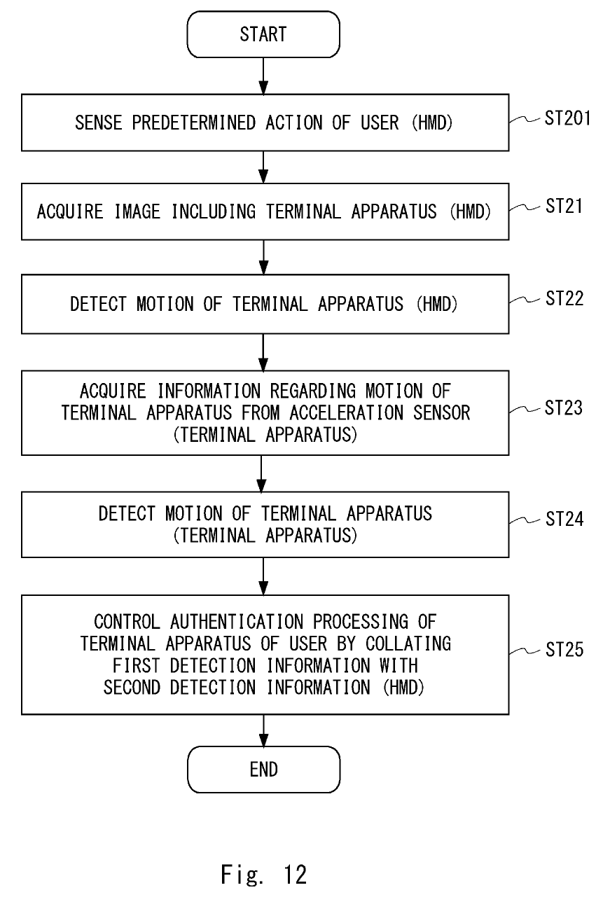

Next, an authentication control method according to the present disclosure will be described. FIG. 12 is a flowchart illustrating an authentication control method according to the present disclosure. Hereinafter, reference signs illustrated in FIG. 11 are appropriately used. Here, it is assumed that the user wears the HMD 600 and grips the terminal apparatus 700. Parentheses illustrated in FIG. 12 indicate the subject of each step.

First, as illustrated in FIG. 12, the user performs a predetermined action. As a result, the action sensing unit 604 senses a predetermined motion of the user (step ST201). For example, the action sensing unit 604 senses a motion in which the user grips the terminal apparatus 700.

As illustrated in FIG. 12, in a case where step ST201 is executed, processing of steps ST21 to ST25 is executed. Since the processing in steps ST21 to ST25 is similar to that in FIG. 5, the description thereof will be omitted.

### Effects

As described above, in the authentication control method illustrated in FIG. 12, in a case where a predetermined motion of the user is sensed, the processing of the first detection unit, the second detection unit, and the authentication control unit is executed. With such a configuration, in the authentication control method according to the present disclosure, the authentication process is started in a case where the user performs a predetermined motion. Therefore, in the authentication control method according to the present disclosure, unintended authentication can be suppressed. In other words, in the authentication control method according to the present disclosure, it is possible to suppress false authentication and improve security.

### Improvement in Accuracy

The authentication control system 500 may be configured to be able to register a plurality of predetermined actions. Specifically, the authentication control system 500 may be configured to be able to register a plurality of predetermined actions in accordance with the physical characteristics of the user, for example, gender and height. As a result, in the authentication control system 500, even in a case where the user cannot accurately perform a specific head motion, for example, even in a case where it is difficult to perform an action such as shaking the head twice due to neck injury or physical restriction, the authentication process is appropriately started by performing a different action.

The authentication control system 500 may be configured to issue a warning notification to at least one of the HMD 600 and the terminal apparatus 700 in a case where the action sensing unit 604 cannot sense the predetermined action of the user. As a result, the user can change the location by the warning and appropriately start the authentication process. In a case where the action sensing unit 604 cannot sense the predetermined action of the user, for example, it is an environment where there is strong vibration and an environment where the illuminance exceeds the upper limit value of the action sensing unit 604 or falls below the lower limit value of the action sensing unit 604. In such a case, the authentication control system 500 may be configured to adjust the matching degree to prevent false authentication. As a result, the authentication control system 500 can cope with various use environments and improve practicality.

### Distribution Processing

The authentication control apparatus 10 and the authentication control systems 100, 200, 300, 400, and 500 have been described above. The processing of each functional block of the authentication control apparatus 10 is not limited to being executed in a single apparatus, and each processing may be configured to be distributed and processed by an apparatus and a server. In the authentication control systems 100 and 500, the configuration in which the processing is executed by the HMD and the terminal apparatus has been described, but the processing may be executed by the HMD, the terminal apparatus, and the server. In the authentication control systems 200, 300, and 400, the configuration in which the processing is executed by the HMD, the terminal apparatus, and the server has been described, but the processing may be executed by the HMD and the terminal apparatus.

### Configuration Example

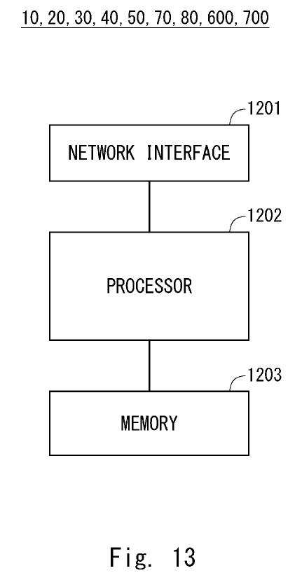

FIG. 13 is a block diagram illustrating a configuration example of an HMD, a terminal apparatus, and an authentication control apparatus according to the present disclosure. FIG. 13 is a block diagram illustrating a configuration example of the above-described HMD, terminal apparatus, and authentication control apparatus (hereinafter, referred to as the terminal apparatus 30 and the like). Referring to FIG. 13, the terminal apparatus 30 and the like include a network interface 1201, a processor 1202, and a memory 1203. The network interface 1201 may be used to communicate with network nodes. The network interface 1201 may include, for example, a network interface card (NIC) conforming to IEEE 802.3 series. IEEE represents Institute of Electrical and Electronics Engineers.

The processor 1202 reads and executes software (computer program) from the memory 1203, thereby performing processing of the terminal apparatus 30 and the like described using the flowchart in the above-described example embodiment. The processor 1202 may be, for example, a microprocessor, a micro processing unit (MPU), or a central processing unit (CPU). The processor 1202 may include a plurality of processors.

The memory 1203 is constituted by a combination of a volatile memory and a nonvolatile memory. The memory 1203 may include a storage arranged away from the processor 1202. In this case, the processor 1202 may access the memory 1203 via an input/output (I/O) interface (not illustrated).

In the example of FIG. 13, the memory 1203 is used to store a software module group. The processor 1202 can perform the processing of the terminal apparatus 30 and the like described in the above-described example embodiment by reading and executing these software module groups from the memory 1203.

As described with reference to FIG. 13, each of the processors included in the terminal apparatus 30 and the like executes one or a plurality of programs including a command group for causing a computer to perform the algorithm described with reference to the drawings.

In the above-described example, the program includes a command group (or software codes) for causing the computer to perform one or more functions described in the example embodiments, in a case of being read by the computer. The program may be stored in a non-transitory computer-readable medium or a tangible storage medium. As an example and not by way of limitation, the computer-readable medium or the tangible storage medium includes a random-access memory (RAM), a read-only memory (ROM), a flash memory, a solid-state drive (SSD) or any other memory technique, a CD-ROM, a digital versatile disc (DVD), a Blu-ray (registered trademark) disc or any other optical disc storage, and a magnetic cassette, a magnetic tape, a magnetic disk storage, or any other magnetic storage device. The program may be transmitted through a transitory computer-readable medium or a communication medium. The program is included in the program product. As an example and not by way of limitation, the transitory computer-readable medium or the communication medium includes propagated signals in electrical, optical, acoustic, or any other form.

Although the present disclosure has been described in accordance with the above example embodiments, the present disclosure is not limited to the configuration of the above example embodiments, and includes various modifications, corrections, and combinations that can be made by those skilled in the art within the scope of the claims of the present application.

Each drawing is merely illustrative for describing one or more example embodiments. Each of the drawings is not associated with only one specific example embodiment, but may be associated with one or more other example embodiments. As those skilled in the art will appreciate, various features or steps described with reference to any one of the drawings may be combined with features or steps illustrated in one or more other drawings, for example, to create an example embodiment that is not explicitly illustrated nor described. All of the features or steps illustrated in any one of the drawings for describing illustrative example embodiments are not necessarily mandatory, and some features or steps may be omitted. The order of the steps described in any one of the drawings may be changed as appropriate.

Some or all of the example embodiments described above may also be described as, but are not limited to, the following Supplementary Notes.

### Supplementary Note 1

An authentication control apparatus including:

a first detection unit that detects first detection information including at least one of a motion of a terminal apparatus of a user and an action of the user with respect to the terminal apparatus;

a second detection unit that detects second detection information that is information related to the first detection information and includes at least one of the motion of the terminal apparatus and the action of the user with respect to the terminal apparatus by a method different from that of the first detection unit; and

an authentication control unit that controls authentication processing of the terminal apparatus of the user by collating the first detection information with the second detection information.

### Supplementary Note 2

The authentication control apparatus according to Supplementary Note 1, wherein

the first detection unit detects the first detection information based on an image acquired using a head mounted display, and

the second detection unit detects the second detection information based on information acquired using the terminal apparatus of the user.

### Supplementary Note 3

The authentication control apparatus according to Supplementary Note 2, further including a presentation control unit that controls the head mounted display or the terminal apparatus to present, to the user, instruction information indicating an instruction related to an action of the user with respect to the terminal apparatus.

### Supplementary Note 4

The authentication control apparatus according to Supplementary Note 3, wherein the presentation control unit controls the head mounted display to display information instructing to perform an action within a predetermined range as the instruction information.

### Supplementary Note 5

The authentication control apparatus according to Supplementary Note 1 or 2, further including a registration unit that registers pattern information including at least one of a motion of the user and a motion of the terminal apparatus accompanying the motion of the user,

wherein the authentication control unit further controls the authentication processing by performing collation including the pattern information.

### Supplementary Note 6

The authentication control apparatus according to Supplementary Note 1 or 2, further including an action sensing unit that senses a predetermined motion of the user,

wherein processing of the first detection unit, the second detection unit, and the authentication control unit is executed in a case where the action sensing unit senses the predetermined motion of the user.

### Supplementary Note 7

The authentication control apparatus according to Supplementary Note 1 or 2, wherein

the first detection information and the second detection information are motions of the terminal apparatus, and

the authentication control unit executes the authentication processing of the terminal apparatus in a case where a similarity between the motion of the terminal apparatus of the first detection information and the motion of the terminal apparatus of the second detection information is a predetermined value or more.

### Supplementary Note 8

The authentication control apparatus according to Supplementary Note 1 or 2, wherein

the first detection information and the second detection information are actions of the user with respect to the terminal apparatus, and

the authentication control unit executes the authentication processing for the terminal apparatus in a case where a similarity between an action of the user with respect to the terminal apparatus of the first detection information and an action of the user with respect to the terminal apparatus of the second detection information is a predetermined value or more.

### Supplementary Note 9

An authentication processing system including a head mounted display, a terminal apparatus, and a server, wherein

the head mounted display:

detects first detection information including at least one of a motion of a terminal apparatus of a user and an action of the user with respect to the terminal apparatus; and

transmits the first detection information to the server,

the terminal apparatus:

detects second detection information that is information related to the first detection information and includes at least one of the motion of the terminal apparatus and the action of the user with respect to the terminal apparatus; and

transmits the second detection information to the server, and

the server

controls authentication processing of the terminal apparatus of the user by collating the first detection information with the second detection information.

### Supplementary Note 10

An authentication control method including processing of,

by a computer:

detecting first detection information including at least one of a motion of a terminal apparatus of a user and an action of the user with respect to the terminal apparatus;

detecting second detection information that is information related to the first detection information and includes at least one of the motion of the terminal apparatus and the action of the user with respect to the terminal apparatus by a method different from detection of the first detection information; and

controlling authentication processing of the terminal apparatus of the user by collating the first detection information with the second detection information.

### Supplementary Note 11

A program causing a computer to execute processing of:

detecting first detection information including at least one of a motion of a terminal apparatus of a user and an action of the user with respect to the terminal apparatus;

detecting second detection information that is information related to the first detection information and includes at least one of the motion of the terminal apparatus and the action of the user with respect to the terminal apparatus by a method different from detection of the first detection information; and

controlling authentication processing of the terminal apparatus of the user by collating the first detection information with the second detection information.

Some or all the elements (for example, configurations and functions) described in Supplementary Notes 2 to 8 dependent on Supplementary Note 1 may also be dependent on Supplementary Notes 9 to 11 due to the same dependency relationship as Supplementary Notes 2 to 8. Some or all of the elements described in any Supplementary Note may be applied to various types of hardware, software, recording means for recording software, systems, and methods.

1. An authentication control apparatus comprising:
at least one memory storing instructions; and
at least one processor configured to execute the instructions to:
detect first detection information including at least one of a motion of a terminal apparatus of a user and an action of the user with respect to the terminal apparatus;
detect second detection information that is information related to the first detection information and includes at least one of the motion of the terminal apparatus and the action of the user with respect to the terminal apparatus by a method different from detection of the first detection information; and
control authentication processing of the terminal apparatus of the user by collating the first detection information with the second detection information.

2. The authentication control apparatus according to claim 1, wherein the at least one processor is further configured to execute the instructions to :
detect the first detection information based on an image acquired using a head mounted display, and
detect the second detection information based on information acquired using the terminal apparatus of the user.

3. The authentication control apparatus according to claim 2, wherein the at least one processor is further configured to execute the instructions to control the head mounted display or the terminal apparatus to present, to the user, instruction information indicating an instruction related to an action of the user with respect to the terminal apparatus.

4. The authentication control apparatus according to claim 3, wherein the at least one processor is further configured to execute the instructions to control the head mounted display to display information instructing to perform an action within a predetermined range as the instruction information.

5. The authentication control apparatus according to claim 1, wherein the at least one processor is further configured to execute the instructions to :
register pattern information including at least one of a motion of the user and a motion of the terminal apparatus accompanying the motion of the user,
control the authentication processing by performing collation including the pattern information.

6. The authentication control apparatus according to claim 1,
wherein the at least one processor is further configured to execute the instructions to :sense a predetermined motion of the user,
when sense the predetermined motion of the user , processing of detecting the first detection informataion, and processing of detecting the second detection informataion, and processing of controling the authentication processing.

7. The authentication control apparatus according to claim 1, wherein
the first detection information and the second detection information are motions of the terminal apparatus, and
wherein the at least one processor is further configured to execute the instructions to control executes the authentication processing of the terminal apparatus in a case where a similarity between the motion of the terminal apparatus of the first detection information and the motion of the terminal apparatus of the second detection information is a predetermined value or more.

8. The authentication control apparatus according to claim 1, wherein
the first detection information and the second detection information are actions of the user with respect to the terminal apparatus, and
wherein the at least one processor is further configured to execute the instructions to control executes the authentication processing for the terminal apparatus in a case where a similarity between an action of the user with respect to the terminal apparatus of the first detection information and an action of the user with respect to the terminal apparatus of the second detection information is a predetermined value or more.

9. An authentication control method causing a computer to execute:
detecting first detection information including at least one of a motion of a terminal apparatus of a user and an action of the user with respect to the terminal apparatus;
detecting second detection information that is information related to the first detection information and includes at least one of the motion of the terminal apparatus and the action of the user with respect to the terminal apparatus by a method different from detection of the first detection information; and
controlling authentication processing of the terminal apparatus of the user by collating the first detection information with the second detection information.

10. A non-transitory computer-readable medium storing a program for causing a computer to execute:
detecting first detection information including at least one of a motion of a terminal apparatus of a user and an action of the user with respect to the terminal apparatus;
detecting second detection information that is information related to the first detection information and includes at least one of the motion of the terminal apparatus and the action of the user with respect to the terminal apparatus by a method different from detection of the first detection information; and
controlling authentication processing of the terminal apparatus of the user by collating the first detection information with the second detection information.
